(19) United States
(12) Patent Application Publication
(10) Pub. No.: US 2003/0219363 A1
(43) Pub. Date: Nov. 27, 2003

(54) Examining chemical reactions

(76) Inventors: Ryszard J. Kobylecki, Wicken (GB); Michael Bruce, Cambridge, MA (US); Gert J. Gruter, Heemstede (NL); Roy Partington, Walton-on-Thames (GB); Adrianus H.J.F. De Keijzer, Hoogerheide (NL); Yves Ramjoie, Roermond (NL); Mirko Kranenburg, Maastricht (NL)

Correspondence Address: PILLSBURY WINTHROP, LLP, P.O. BOX 10500, MCLEAN, VA, 22102, US

(21) Appl. No.: 10/147,317

(22) Filed: May 17, 2002

(51) Int. Cl. B01J 8/04

(52) U.S. Cl. 422/188

(57) ABSTRACT

A system and method for examining chemical reactions, especially catalysed polymerisation reactions, uses an array of apparatuses 2 within a nitrogen filled glove box 42. A multi-pipetting robot 40 is arranged to deliver measured amounts of materials (e.g. catalyst components) to mixing vessels 24 which in turn are arranged to deliver the components to reactors 4 into which other components (e.g. monomer gases) are fed. A range of variables for reactions undertaken in apparatuses 2 are controlled by a computer 45 which also stores data relating to reactions effected in a database. A library of products can be made using the system under carefully controlled and reproducible conditions and parameters affecting the properties of products produced can be investigated.

This invention relates to the examination of chemical reactions and particularly, although not exclusively, relates to the examination of reactions involving a catalyst system. Preferred embodiments relate to a method of examining the effect in a chemical reaction, for example an olefin polymerisation reaction, of varying selected variables and apparatus therefor.

Catalysts are widely used in polymerisation reactions. However, assessment of the effect and/or efficiency of catalysts and other variables in polymerisation reactions is extremely slow and time-consuming. It is an object of the present invention to address such problems.

According to a first aspect of the invention, there is provided a method of examining the effect in a chemical reaction of varying selected variables, the method comprising preparing a first product using a first set of experimental variables and preparing a second product using a second set of experimental variables, wherein data relating to said first and second sets is stored by an electronic data storage means, for example a computer.

The invention extends to a method of high-throughput screening of chemical reactions, the method comprising preparing a first product using a first set of experimental variables and preparing a second product using a second set of experimental variables, wherein data relating to said first and second sets is stored by an electronic data storage means, for example a computer.

The invention extends to a method of making a library of products, the method comprising varying experimental variables between chemical reactions in order to prepare a multiplicity of products, wherein data relating to experimental variables used for preparing each product is stored by an electronic data storage means, for example a computer.

The invention extends to a method of effecting automatically a multiplicity of chemical reactions, the method comprising preparing individual products using respective sets of experimental variables, wherein data relating to said sets is stored by an electronic data storage means, for example a computer and, preferably, the preparation of said products is computer controlled.

In general terms, the methods may be used in relation to any reactions in which one or more components need to be delivered at greater than ambient pressure, especially at relatively high pressures of up to 100 bar. Said one or more components may be reactive components, solvents and/or catalysts. Said one or more components may be gases, high pressure liquids (i.e. substances that act as liquids but which must be compressed and kept contained in order to remain a liquid, such as isobutane, ammonia, isobutylene and butene) and/or supercritical liquids.

The methods may be used in relation to hydrogenations, hydroformylations, reductions (e.g. hydrogen or liquid ammonia reductions), polymerisations, oligomerisations, carbonylations, isobutylene reactions and reactions involving carbon dioxide.

The methods may be used for optimising any type of reaction, for example a reaction involving the preparation of an active ingredient, for example a drug. Advantageously, the methods may be used in parallel exploration of scale-up reactions for preparation of active ingredients, suitably on a relatively large (g or Kg) scale.

Preferably, the reaction involves the use of a catalyst system and the method involves examining the effect of varying selected variables relating to said catalyst system.

The methods are suitably for measuring the effect of varying selected variables in a polymerisation reaction, wherein said first and second products (preferably a multiplicity of products prepared) are suitably polymers, prepared by polymerisation of one or more monomers in the presence of a catalyst system.

A reactor means is preferably provided in which said first and second products are prepared. Said reactor means suitably has a volume of at least 25 ml, preferably at least 50 ml, more preferably at least 75 ml, especially at least 100 ml. The volume suitably is less than 500 ml, preferably less than 300 ml, more preferably less than 200 ml, especially less than 150 ml. Said reactor means preferably includes an agitator means for agitating, for example by stirring, the contents of the reactor means. Means for varying the extent of agitation provided by the agitator means is preferably provided. One of the experimental variables in said first and second sets may be related to the extent of agitation. The method may, therefore, include the step of varying the extent of agitation between at least two chemical reactions for examining the effect of varying the agitation on the chemical reaction under consideration. The method preferably includes storing data relating to the agitation, for example the stirring rate. Said extent of agitation is preferably controlled by a computer and more preferably is controlled by said computer which stores data relating to first and second sets of variables.

In one embodiment, the power supplied to a stirrer provided in the reactor means may be monitored and data relating thereto stored in the data storage means. Such data may give an indication on the viscosity of fluid in the reactor means during a reaction. For example, if the frequency of the stirrer is kept constant, the power supplied to the stirrer can give an indication of viscosity of the material being stirred.

The method preferably includes heating said reactor means. The method may include cooling said reactor means. Heating and/or cooling of said reactor means are preferably controlled by a computer, more preferably by said computer which stores data relating to said first and second sets of variables. The method preferably includes storing data relating to the temperature in said reactor means, during the chemical reaction.

The method preferably includes supplying via a first supply means one or more components for the reaction to the reactor means. Said supply is preferably controlled by a computer, more preferably by said computer which stores data relating to said first and second sets of variables. Said computer preferably controls the opening and closing of a valve for controlling said supply. One, preferably a plurality, of the experimental variables in said first and second sets is related to the supply of said one or more components via said first supply means. The method preferably includes storing data relating to the supply of the said one or more components. The method may include storing data relating to (and/or experimental variables in said first and second sets may be based on) at least one, suitably at least two, preferably at least three, more preferably at least four, especially each of the following: the identity of said one or more components supplied; the timing of the supply of said component(s) in the context of the chemical reaction; the rate at which said one or more components is supplied; the pressure at which said one or more components is supplied; the total amount of each of said one or more components supplied in a chemical reaction.

Preferably, in the method, a first substance is supplied via said first supply means. Said first substance is preferably a reactant. Suitably, at least a part of said first substance is incorporated into a product produced in the reaction. Said substance may be a fluid, especially a gas. Where a polymer is prepared in the reaction, said first substance is preferably a monomer gas. Preferably, said monomer gas is an optionally-substituted olefin which term includes cyclic olefins and dienes. Examples of simple olefins include, for example ethylene, propylene, butene, pentene, heptene and octene, with propylene and especially ethylene being preferred. Examples of substituted olefins include vinyl compounds, for example styrene, acrylic acid, esters thereof and acrylonitrile. An example of a cyclic olefin is norbornene. Examples of dienes include butadiene and isoprene. Said first substance may be supplied at a pressure up to 100 bar, preferably up to 50 bar, more preferably up to 30 bar. As aforesaid, the pressure of the supply of said first substance may be an experimental variable in the method. The pressure may vary between 1-100 bar, especially 1-30 bar.

Preferably, in the method, a plurality (preferably three or more) components for the reaction are supplied into a region, for example a receptacle or manifold, upstream of the reactor means and suitably caused to become mixed therein. Thereafter, the components can flow from the region into the reactor means. Advantageously, in this case, the method may be used when two components (especially fluids and/or gases) are used in the chemical reaction and, suitably, at least a part of each of said two components is incorporated into a product produced in the reaction. Where a polymer is prepared in the reaction, said two components may be reactants and may both be monomer gases, with ethylene and propylene being examples thereof. Other components may be supplied into said region. For example, a solvent, especially a high pressure liquid may be supplied. Also, a reaction intermediary (e.g. a chain transfer agent or the like) may be supplied.

The method may include assessing the amount of at least one (preferably a plurality) of said components for the reaction present in said reactor means at a plurality of intervals during a reaction in said reactor means. The method preferably includes sampling from the reactor means at intervals during a reaction. Preferably, fluids, for example gases are sampled. The method may utilise any suitable means for assessing the amount(s) of said component(s). Mass spectroscopy is preferred, especially where the amounts of a plurality of components are assessed.

The method preferably includes supplying via a second supply means one or more components for the reaction to the reactor means. Said supply is preferably controlled by a computer, more preferably by said computer which stores data relating to said first and second sets of variables. Said computer preferably controls the opening and closing of valves for controlling said supply. One, preferably a plurality, of the experimental variables in the first and second sets is related to the supply of said one or more components via said second supply means. The method preferably includes storing data relating to the supply of said one or more components. The method may include storing data relating to (and/or experimental variables in said first and second sets may be based on) at least one, suitably at least two, preferably at least three, more preferably at least four, especially each of the following: the identity of said one or more components supplied; the timing of the supply of said component(s) in the context of the chemical reaction; the order of supply of said component(s); the rate at which said one or more components is supplied; the pressure at which said one or more components is supplied; and the total amount of each of said one or more components supplied in a chemical reaction.

The order of supply of components into the reactor via said first and second supply means may be an experimental variable included within said first and second sets and/or data relating to the order may be stored.

Preferably, in the method, a second substance is supplied via said second supply means. Said second substance could be a substrate, monomer, anti-static agent, chain termination agent or inert filler. Said second substance may comprise a catalyst system or a component of a catalyst system. Suitably, a said catalyst system is arranged to catalyse a reaction, suitably involving a first substance which may be supplied via said first supply means and/or could be supplied via said second supply means. Optional further substances may be supplied via said second supply means.

At least 0.1 μg, preferably at least 0.5 μg, more preferably at least 0.75 μg, especially at least 1 μg of said second substance may be supplied. The amount of said second substance may be less than 5000 μg, preferably less than 3000 μg, more preferably less than 1500 μg, especially 1000 μg or less. The aforementioned amounts suitably relate to the weight of active material, not including any support therefor. The amount of said second substance may be an experimental variable included within said first and second sets and/or data relating to said amount may be stored. The amount of catalyst may be varied within wide limits, suitably up to a stoichiometric amount relative to other reactants involved in the reaction.

The method preferably includes injecting said second substance and one or more optional further substances into the reactor means, suitably under pressure, which is preferably predetermined. The injection is preferably controlled by a computer, more preferably by said computer which stores data relating to said first and second sets of variables. Said computer preferably controls the opening and closing of valves for controlling said injection. To this end, upstream of the reactor means, there is suitably provided a fluid reservoir means for receiving material, for example, fluid (e.g. liquid) to be injected in the reactor means. The method preferably includes generating pressure in the fluid reservoir means. The fluid reservoir means suitably has a volume of at least 2 ml, preferably at least 3 ml, more preferably at least 4 ml. The volume may be less than 50 ml, suitably less than 30 ml, preferably less than 20 ml, more preferably less than 10 ml, especially 6 ml or less. Suitably, in the method, at least 40%, preferably at least 60%, especially at least 80%, of the volume of the reservoir means is filled with a non-gaseous material for injection into the reactor means. Said reservoir means may have a volume up to 20% of the volume of the reactor means.

The method may include delivering a fluid, especially a gas, for example an inert gas such as nitrogen or argon, under pressure into the fluid reservoir means. The method preferably includes pressurising the fluid reservoir means and then causing the contents thereof to be injected into the reactor means. Preferably, a computer, more preferably said computer which stores data relating to said first and second sets of variables causes said injection, suitably by opening and/or closing valves.

A catalyst system or a component of said catalyst system supplied via said second supply means may be prepared in the method. Alternatively, a pre-prepared catalyst system or component may be supplied via said second supply means. Where a catalyst system or component is prepared in the method, the method preferably includes storing data relating to the preparation of said catalyst system and/or a component thereof. The catalyst system and/or a component thereof may be oxygen and/or moisture sensitive and, accordingly, its preparation and/or storage is preferably carried out substantially in the absence of oxygen and/or moisture. Preferably, the preparation is carried out in an inert atmosphere, for example a nitrogen or helium atmosphere or, especially, an argon atmosphere. Preferably, the preparation is carried out in an inert gas-filled environment, for example a glove box. Said catalyst system or a component thereof may be prepared by contacting a first catalyst component with a second catalyst component and, optionally, with other catalyst components. The preparation is preferably computer controlled, more preferably by said computer which stores data relating to said first and second sets of variables. The method preferably includes storing data relating to (and/or experimental variables in said first and second sets may be based on) at least one, suitably at least two, preferably at least three, especially each of the following: the identity of said first catalyst component; timing of the supply of said first catalyst component; the order of the supply of said first catalyst component relative to other components of the catalyst system; and the amount of said first catalyst component added.

The method preferably includes storing data relating to (and/or experimental variables in said first and second sets may be based on) at least one, suitably at least two, preferably at least three, especially each of the following: the identity of said second catalyst component; the timing of the supply of said second catalyst component; the order of supply of said second catalyst component relative to other components of said catalyst system; and the amount of said second catalyst component added.

Where the catalyst system includes other catalyst components, data relating to such components may be stored as described above for said first and second catalyst components.

The method may include preparing said catalyst system or a component thereof upstream of a reactor means in which products of the chemical reaction are prepared. Where the method includes injecting said catalyst system or a component thereof from a fluid reservoir means into the reactor means, preferably the method includes preparing said catalyst system or a component thereof upstream of the fluid reservoir means. The method may include preparing the catalyst system or components thereof in a preparation receptacle.

Said catalyst system may be for any type of chemical reaction, for example a hydrogenation reaction or any other reaction described herein. Preferably, however, it catalyses a polymerisation reaction, suitably for preparation of an organic polymer. It may polymerise the polymerisation of vinylacetate. Said catalyst system is suitably for preparation of polyolefins and preferably catalyses the polymerisation of ∝-olefins which may be selected from ethylene, propylene, butene, pentene, heptene and octene. The method may be adapted to polymerise mixtures of polyolefins. Preferred ∝-olefins are ethylene and/or propylene. The use of such olefins can lead to the formation of crystalline polyethylene homopolymers and copolymers of both low and high density (HDPE, LDPE, LLDPE etc) and polypropylene homopolymers and copolymers (PP and EMPP). The catalyst system may also be used in the preparation of amorphous or elastomeric copolymers based on ethylene and another ∝-olefin. Propylene may be used as the other ∝-olefin, so that EPM elastomer is formed. A diene could be used besides ethylene and the other ∝-olefin, so that so-called EADM elastomer is formed, in particular EPDM (ethylene propylene diene) elastomer. An ethylene-norbornene elastomer could also be formed. The monomers needed for such products and the processes to be used are known to those skilled in the art.

Said catalyst system may be any type of catalyst system that it is desired to assess. However, it may be a highly sensitive catalyst system which is unstable in an oxygen and/or moist atmosphere. The catalyst may be inorganic. It may be a metallocene. The catalyst system may be as described in U.S. Pat. No. 5,646,322 (DSM), EP 0427 697 (Fina) or EP 0420436 (Exxon) and the contents of the aforementioned documents are incorporation therein by reference.

In the method, a robot, especially a multi-pipetting, x, y, z robot, suitably delivers components for said chemical reaction. Preferably, said robot is involved in the preparation of said catalyst system or a component thereof, for example the contacting of a said first catalyst component with a said second catalyst component. Preferably, said robot delivers said first and second catalyst components to a place where they are contacted. Where the catalyst system or a component thereof is prepared in a preparation receptacle, preferably said robot delivers said first and second catalyst components to said receptacle. Said robot is preferably arranged to deliver predetermined, optionally variable, amounts of components. Said robot is preferably controlled by a computer and, more preferably, is controlled by said computer which stores data relating to said first and second sets of variables. It will be appreciated that the preparation of said catalyst system or a component thereof is suitably automatically executed under computer control.

Suitably, a said chemical reaction which takes place in said reactor means and is examined in the method is carried out for less than 3 hours, preferably less than 2½ hours, more preferably less than 2 hours, especially less than 1 hour. Where a solution polymerisation is effected, the reaction could be 1 hour or less and is, suitably, about ½ hour. Where a slurry polymerisation is effected, the reaction could be longer, for example between ½ hour and 2 hours.

After termination of a chemical reaction, the product produced may be removed from the apparatus preferably automatically, under the control of a computer which suitably controls operation of a valve associated with an outlet of the reactor means. Suitably, a fluid path is defined between the reactor means and a collection vessel. A robot, or other means, may be provided for removing, preferably automatically, the collection vessel from said fluid path after a reaction and replacing the removed vessel so as to collect a subsequent product prepared in the apparatus. After collection of a product, it may be analysed, for example by GPC and by other techniques and data relating to the analysis is input into the electronic data storage means, suitably said computer.

In a preferred embodiment, said collection vessel is a component of a collection assembly which is preferably disengaged from a said reactor means in the method. The method preferably involves a robot twisting the collection assembly about a first axis and, suitably, moving the assembly in a direction parallel to said first axis. The method may include a robot disengaging said collection vessel (suitably containing a reaction product) from the collection assembly and placing the collection vessel in a predetermined location. The method may include replacing the removed collection vessel with another collection vessel. Thereafter, the method may include re-engaging the collection assembly with the reactor means.

The method preferably includes cleaning the reactor after a reaction has been undertaken. Such cleaning is preferably carried out automatically, suitably according to a predetermined procedure, preferably under control of a computer.

Advantageously, sufficient data is stored relating to each chemical reaction undertaken to enable chemical reactions to be reproduced to produce substantially identical products, under computer control.

Selection of values for variables in said first and second sets may be under operator control. However, additionally, or alternatively, selection of variables may be under computer control. In this case, variables may be adjusted in dependence upon assessments made with respect to earlier reactions.

The method suitably includes analysing the data relating to said first and second sets of variables and determining the effect of individual variables on the chemical reactions and/or characteristics of products produced.

The method may involve undertaking at least 5, suitably at least 10, preferably at least 15, more preferably at least 20, especially at least 40, separate reactions to prepare products using experimental variables as described. Data relating to all of the reactions may be stored for analysis. Advantageously, because reactions can be carried out relatively rapidly, with a high level of automation, more than 15 reactions may be carried out using a single apparatus arranged to carry out the methods described in a day. In fact, because of the high level of automation, the apparatus can be left unattended overnight.

When the method is used to screen a new catalyst 5-10 reactions may be undertaken. Where the method is used to optimize variables, thousands of reactions may be undertaken. It will be appreciated that the automated system described makes it relatively easy to undertake large numbers of reactions.

A plurality, suitably at least 2, preferably at least 4, more preferably at least 6, especially at least 8, apparatuses (which are preferably substantially identical), may be provided, each of which is arranged to carry out the methods described, suitably in parallel. Thus, said first product described may be prepared by an apparatus and said second product may be prepared by the same or another apparatus. Said plurality of apparatuses may be served by the same robot and may be provided in, or associated with, the same inert gas-filled environment. Furthermore, they may be controlled by the same computer. Thus, advantageously, a single computer may be used to control, independently, the execution of the methods described in each apparatus; and, preferably data collated is stored by the same computer.

Where the methods described are undertaken in parallel using a plurality of apparatus, at least one, suitably at least two, preferably at least three, more preferably at least four, especially at least five of the following variables may be selected for one apparatus independently of another (preferably each other) apparatus:

the extent of agitation in said reactor means;

the temperature in said reactor means;

the pressure at which one or more components is supplied to the reactor means;

the rate at which said one or more components is supplied to the reactor means;

the total amount of one component supplied to the reactor means for a chemical reaction;

the total amount of another component supplied to the reactor means for a chemical reaction;

the ratio of the amount of one component supplied to the reactor means relative to the amount of another component supplied to the reactor means;

the duration of a chemical reaction.

Where the method involves assessing the amount of at least one of said components for the reaction present in said reactor means, and where a plurality of reactor means is used, a single means (e.g. a single mass spectrometer) may be used to asses the amounts of said components.

The invention extends to a system which includes apparatus for carrying out any of the methods described herein.

The invention extends to a system for examining the effect of adjusting selected variables in a chemical reaction, the system comprising an apparatus which includes:

a reactor means;

a first supply means for supplying a first substance to the reactor means;

a second supply means for supplying one or more components for the chemical reaction to the reactor means;

wherein said system includes electronic data storage means, for example a computer, associated with the apparatus for storing sets of variables relating to separate reactions undertaken using the apparatus.

Said reactor means is preferably an autoclave. It is preferably operable at a pressure up to 100 bar and a temperature up to 200° C. Means for heating said reactor means is preferably provided. Means for cooling said reactor means is preferably provided. Means for measuring temperature associated with the reactor means is preferably provided. The apparatus is preferably such that data relating to temperature is relayed to said computer. Said computer preferably controls the heating and/or cooling of the reactor means.

Agitator means is preferably provided in said reactor means. The apparatus is preferably such that data relating to agitation effected by said agitation means is relayed to said computer. Said computer preferably controls said agitator means.

Said first supply means is preferably arranged for the supply of a fluid, especially a gas, preferably under pressure, to said reactor means. Valve means is preferably provided for controlling supply of fluid to said reactor means via said first supply means wherein operation of said valve means is arranged to be controlled by said computer. Means is preferably provided for measuring the amount of fluid passing to said reactor means via said first supply means. The apparatus is preferably such that data relating to said amount is relayed to said computer.

Means may be provided for removing water from fluid prior to passage into the reactor means via said first supply means. Means may be provided for analysing the level of oxygen and/or water in such fluid. The computer may be arranged to control valves to allow gas to flow to an area where it may be automatically analysed.

Means may be provided for supplying two gases, preferably three gases, into the reactor means via said first supply means. In one embodiment, the apparatus may include a receptacle (e.g. a manifold), upstream of the reactor means, wherein said receptacle includes a plurality of gas inlets and said receptacle is arranged for supply of gases from the receptacle into the reactor means via said first supply means.

The apparatus may include a sampling means for withdrawing a fluid (especially a gas) sample from the reactor means and, suitably, directing the sample withdrawn to a remote location for analysis. Preferably, said sampling means extends out of the reactor means via said first supply means. An internal region of said sampling means is, however, suitably isolated from fluids passing into the reaction means via said first supply means. Preferably, an inlet end of said sampling means extends further into the reactor means than an outlet end of the first supply means via which fluids flow into the reactor means. Said inlet end of said sampling means is preferably turned away from said outlet end of the first supply means so that the sampling means receives a representative sample from within the reactor means.

Said system may include means (e.g. a mass spectrometer) for analysing fluid (especially gas) samples withdrawn from said reactor means.

Said second supply means is preferably arranged for the supply of a fluid, especially a liquid, to said reactor means. Means is preferably provided for injecting fluid, under pressure, into said reactor means, suitably against the pressure present in the reactor means. Said means for injecting fluid may include a fluid reservoir means for containing fluid to be injected and means for pressurising the fluid, such means suitably including a gas supply. Thus, preferably, said fluid reservoir means includes a fluid supply line for input of a pressurising gas. The computer is preferably arranged to initiate injection of the fluid into the reactor means. To this end, the computer may be arranged to operate valve means positioned between the reactor means and fluid reservoir means whereby injection takes place when the valve means is operated. The computer may also control operation of a valve upstream of the fluid reservoir means.

The apparatus preferably includes means for removing water from the pressurising gas prior to its passage into the reactor means. Means may be provided for analysing the level of oxygen and/or water in said pressurising gas. The computer may be arranged to control operation of valve means to allow pressurising gas to flow to an area where it may be automatically analysed.

The apparatus preferably includes a preparation receptacle for supplying catalyst(s) (or fluids or solutions or substrate solutions) to the reactor. Said receptacle is preferably upstream of the fluid reservoir means and, suitably, a valve means is arranged between the two, which valve means is suitably arranged to be controlled by the computer.

Said preparation receptacle is preferably arranged in an inert environment. For example, it may be arranged in an inert-gas filled cabinet. Said receptacle is preferably arranged to receive material dispensed by a robot, suitably positioned within the inert environment. Agitation means is preferably associated with said receptacle.

Said system preferably includes said robot which is suitably controlled by said computer. It is preferably arranged to transfer predetermined amounts of materials from storage positions, suitably within the inert environment, into the apparatus, preferably into the preparation receptacle thereof.

A valve means is preferably associated with an outlet of the reactor means for controlling removal of product from the reactor means. A fluid flow path is preferably defined between the reactor means and a collection vessel. Said valve means is preferably computer controlled.

Said collection vessel is preferably a component of a collection assembly which is releasably secured relative to the reactor means. Said collection vessel is preferably disengageable from the collection assembly. Said system preferably includes a robot for releasably securing the collection assembly in position and for disengaging the collection vessel from the collection assembly.

Said system preferably includes a plurality of apparatuses of the type described. Each apparatus in said system is preferably substantially identical. Catalyst preparation receptacles of the apparatuses are preferably provided in the same inert environment. Said robot is preferably arranged to deliver materials into each apparatus under the control of the computer. Preferably, a single computer is provided for communicating information to and receiving information from the plurality of apparatuses. Preferably, said single computer is arranged to control operation of valves means of the apparatuses.

The invention extends to the use of a system of the type described in examining the effect of adjusting selected variables in a chemical reaction.

The invention extends to the use of a system of the type described in high-throughput screening of chemical reactions.

The invention extends to the use of a system of the type described in making a library of products.

The invention extends to a library of products in combination with a database incorporating data for each product, wherein said data relates to experimental variables used for preparing each product.

The invention extends to the use of a system of the type described in effecting automatically a multiplicity of chemical reactions which differ in at least one experimental variable.

The form of automatic control described herein may be applicable not only to the polymerisation reaction focussed on but to any hydrogenation, carbonylation, carboxylation, carboxyalkylation, reduction, oxidation or halogenation reaction. All chemicals, temperatures, pressures, gas evolution, gas consumption etc. can be subject to variation in the course of a chemical process and thus monitoring, control and feedback on variables measured and/or detected allows controlled predictability of the next desired set of variables in an experimental set.

Any feature of any aspect of any invention or embodiment described herein may be combined with any feature of any aspect of any other invention or embodiment described herein.

Specific embodiments of the invention will now be described, by way of example, with reference to the accompanying drawings, in which:

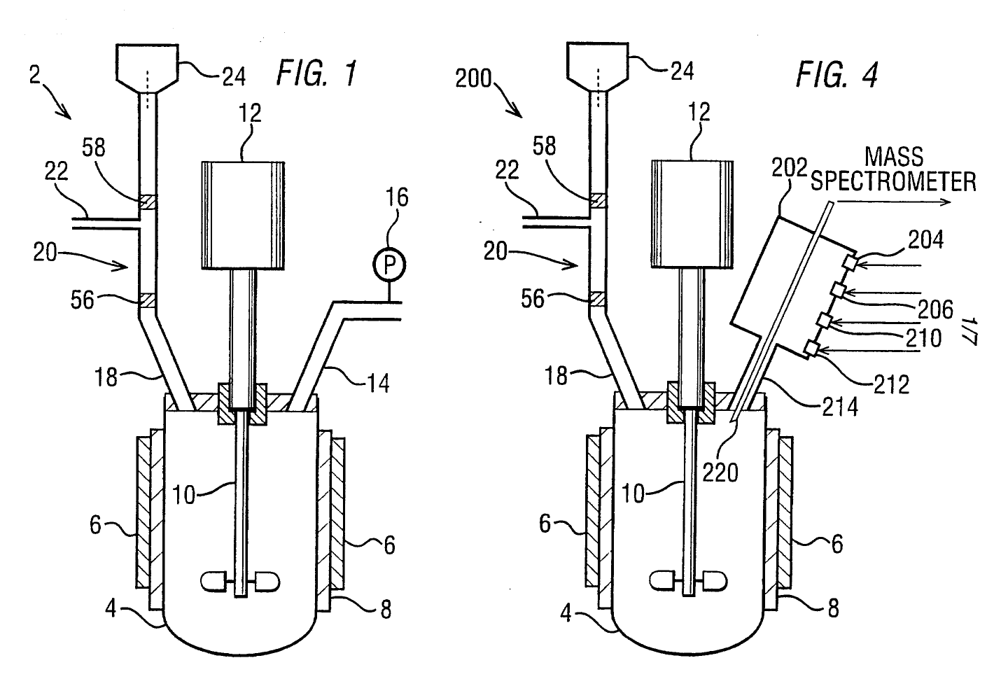

FIG. 1 is a schematic representation of apparatus for preparing a polymer;

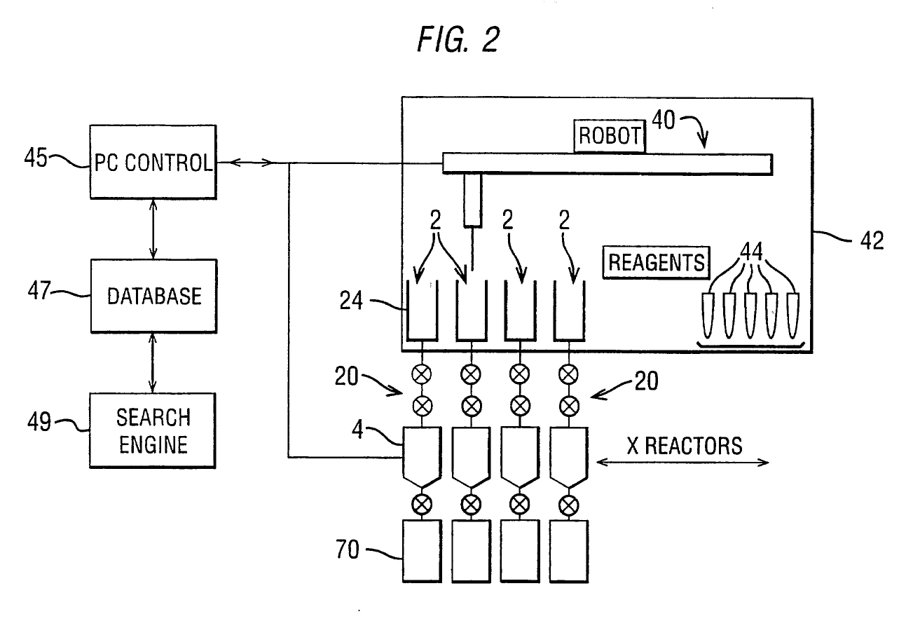

FIG. 2 is a schematic representation of an array of apparatuses for preparing polymers;

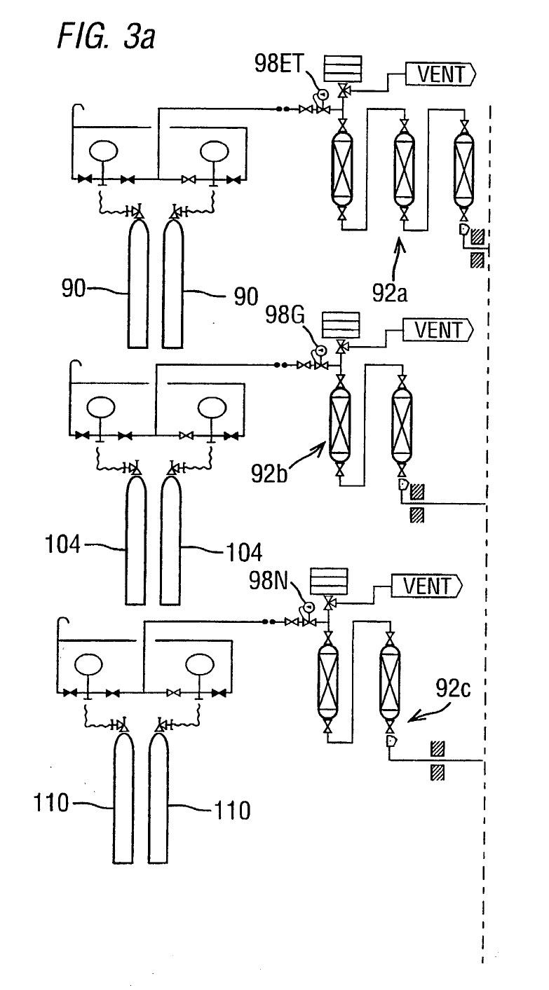

FIG. 3 is a schematic representation of apparatus for preparing a polymer (provided on three separate sheets);

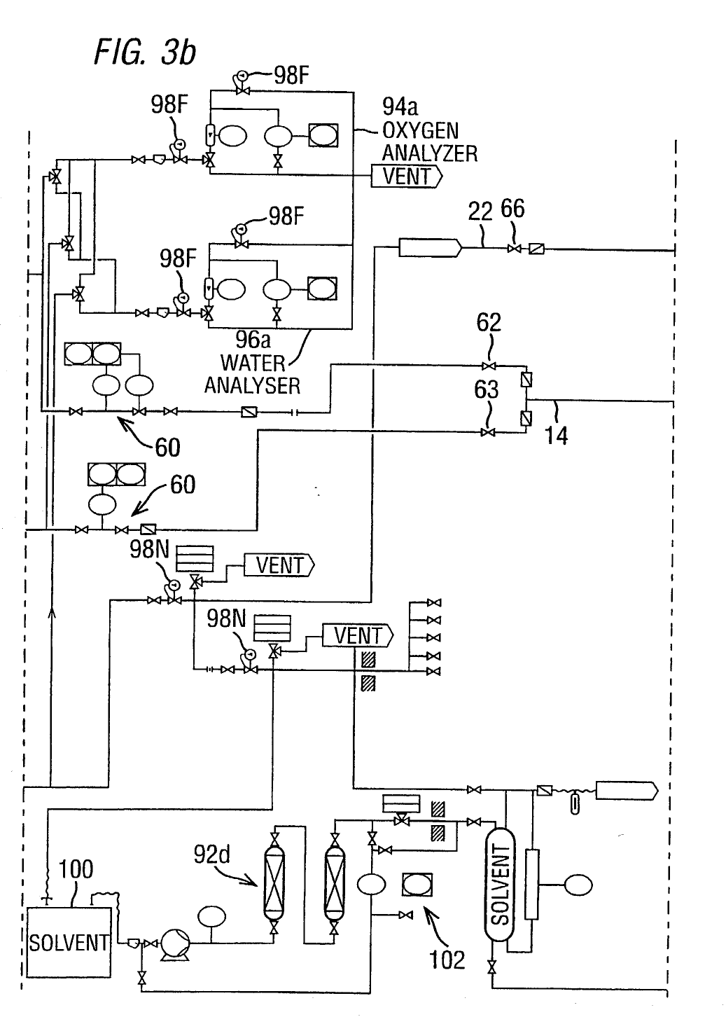

FIG. 4 is a modified version of the apparatus of FIG. 1;

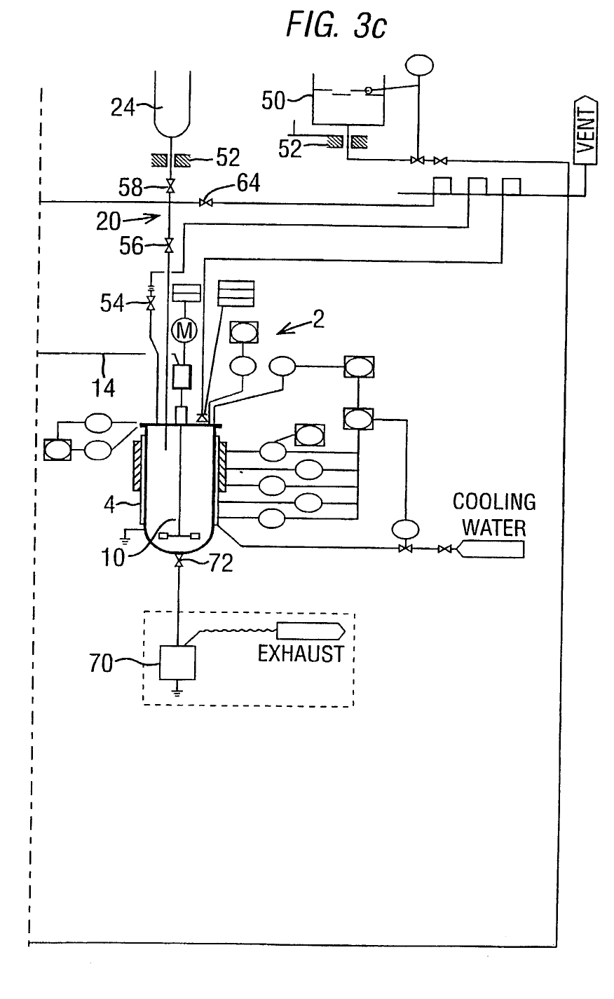

FIG. 5 is a schematic representation of a set-up for sampling from an array of apparatuses of the type shown in FIG. 4 and analysing samples by mass spectroscopy;

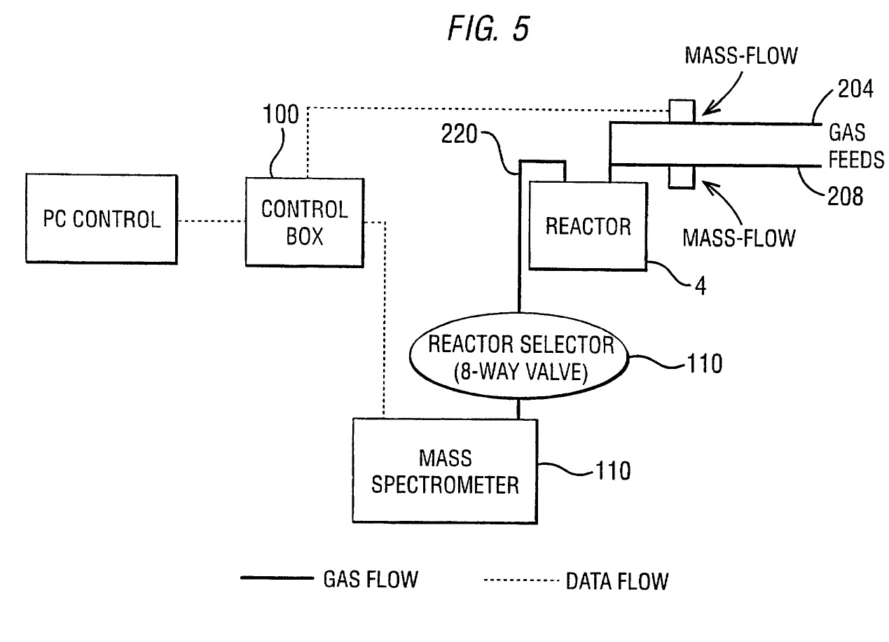

FIG. 6 is a cross-section through a dumping assembly;

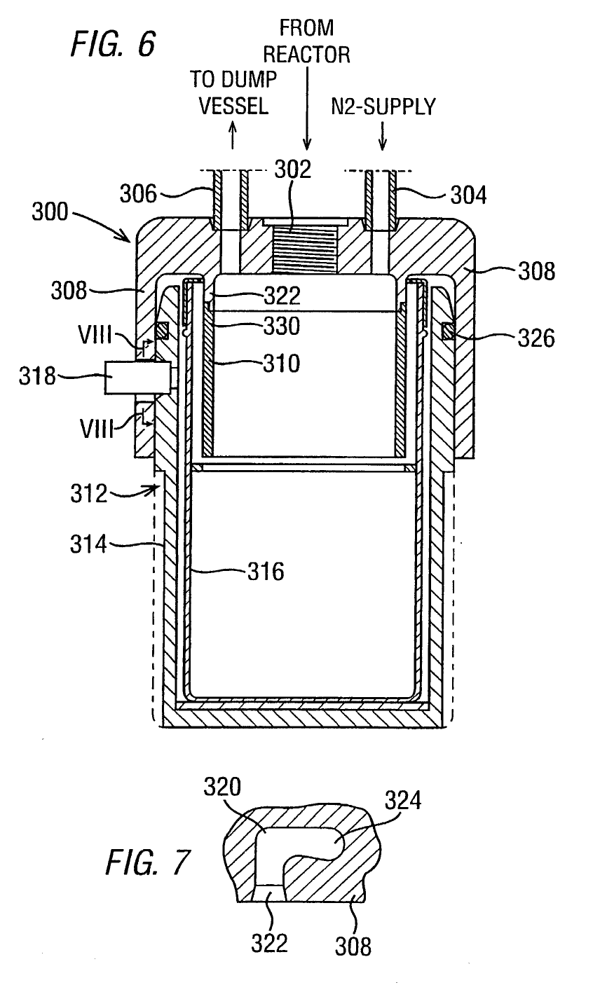

FIG. 7 is a cross-section along line VII-VII through a housing for a dump vessel (with the dump vessel itself omitted in the interests of clarity).

In the figures, the same or similar parts are annotated with the same reference numerals.

Whilst the apparatus is described hereinafter with reference to the preparation of polyethylene, this is only one example of a reaction that may be undertaken. The apparatus may be used for a very wide range of reactions.

In one embodiment, the apparatus may be used in the preparation of polyethylene polymer using ethylene gas, a catalyst and an optional co-catalyst in the presence of an inert solvent, for example pentamethyl heptane (PMH). The apparatus allows the preparation of the polymer under variable but highly controlled, monitored and/or reproducible conditions.

General features of the apparatus are shown in FIG. 1. The apparatus 2 includes a reactor vessel 4, which is surrounded by an electrical heating means 6 and a water-cooling means 8. A stirrer 10 extends into the vessel and is driven by a motor 12. A monomer input line 14 is arranged for passage of ethylene monomer into the vessel, with the pressure of the monomer being monitored by pressure gauge 16. A second input line 18 communicates with the vessel 4 for delivery of reagent(s)/solvent(s) thereinto. Upstream of the line 18, there is provided an injection chamber 20 for receiving reagent(s)/solvent(s) prior to pressurised injection thereof into the vessel 4. The injection chamber 20 communicates with a nitrogen gas supply line 22. A premixing vessel 24 which includes a stirrer (not shown) is arranged upstream of the injection chamber 20 for delivering reagent(s)/solvent(s) thereinto. The premixing vessel is enclosed in a nitrogen-filled glove box. Various valves (not shown) are provided for controlling passage of fluids through the apparatus.

In brief, the apparatus may be used as follows. With the stirrer 10 and heating means 8 actuated and PMH (supplied via line 18) saturated with ethylene (supplied via line 14) being present in the vessel 4, a catalyst is prepared in pre-mixing vessel 24 by contact of a ligand and transition metal in the presence of PMH and a co-catalyst is optionally added to the mixture. The mixture is allowed to pass into injection chamber 20 where it is pressurised by nitrogen gas and injected under pressure into vessel 4 wherein an ethylene polymerisation reaction takes place. During this time, ethylene is continuously supplied into vessel 4 to maintain ethylene saturation. After a time, the reaction is stopped and the polymer prepared is collected and analysed.

In a preferred embodiment, represented schematically in FIG. 2, an array, for example having eight members (only four of which are shown in the figure), of apparatuses 2 are arranged side by side, with their pre-mixing vessels 24 being arranged in a nitrogen filled glove box 42 (<1 ppm H₂O; <1 ppm O₂ atmosphere). A multi-pipetting robot 40 (an X, Y, Z gantry system type) is positioned in the glove box and is arranged to deliver measured amounts of materials (e.g catalyst components, co-catalyst(s), solvent(s) etc.) from vessels 44 into respective pre-mixing vessels 24. The catalyst components and/or the catalyst may be air and/or moisture sensitive organometallic complexes, hence the need for the nitrogen atmosphere. The vessels 4 of the apparatuses 2 may have a volume of 125 ml and be electrically heated and cooled by water. Each can independently run polymerisations of ethylene at up to 100 bar and at temperatures in the range of 50-150° C. The robot 40 and the apparatuses 2 are under the control of a single computer 45 which also stores data relating to reactions effected in a database 47, wherein a search engine 49 is provided for searching the database.

A more detailed representation of apparatus is provided in FIG. 3. Whilst eight apparatuses 2 are suitably provided, with their respective pre-mixing vessels 24 and a solvent supply 50 arranged within the glove box (the floor 52 of which is represented), only one apparatus 2 is shown in the figure. Other components of the apparatus are provided outside the glove box because they are, in any event, effectively sealed from the surrounding atmosphere.

The apparatus of FIG. 3 may be used according to the following description.

Initially, the atmosphere in the glove box is tested to ensure that it contains less than 1 ppm H₂O and less than 1 ppm oxygen gas. Then, before starting a polymerisation experiment, reactor vessel 4 is rinsed, according to a predetermined regime, with the robot delivering suitable solvents, and the computer controlling the opening and closing of valves and operation of heaters.

Upstream of the apparatus 2, ethylene cylinders 90 are provided and arranged to deliver gas at up to 100 bar, via drying columns 92a, Brooks (Trade Mark) flow controller 60 and input line 14, to the reactor vessel 4. (The Brooks flow controller is a mass flow controller. It controls the maximum flow rate of gas in gas lines with which it is associated and the amount, both in terms of the instaneous amount flowing and the total amount delivered). The gas may be diverted for analysis to respective oxygen and water analysis circuits 94a, 96a. Flow of ethylene gas is controlled by valves labelled 98ET, 98F and valve 62 which are, in turn, operated by the computer.

Upstream of the apparatus 2, nitrogen cylinders 110 are provided and arranged to deliver gas, via drying columns 92c, at a pressure in the range 1-100 bar, preferably at about 30 bar, into supply line 22. The gas may be diverted for analysis to respective oxygen and water analysis circuits 94a, 96a. Flow of nitrogen is controlled by valves labelled 98N, 98F and 66 which are, in turn, operated by the computer.

Solvent is supplied to vessel 50 from a vessel 100 via drying columns 92d and, optionally, via a water analyser 102.

Another gas may be input into the ethylene stream, if desired. For example, hydrogen gas may be added to the stream to act as a chain transfer agent and/or to control molecular weight. The facility for inputting another gas includes gas cylinders 104 which are arranged to deliver gas, via drying columns 92b, Brooks flow controller 60 and input line 14, to the reactor. The gas may be diverted for analysis to respective oxygen and water analysis circuits 94a, 96a. Flow of the gas is controlled by valves labelled 98G, 98F and 63 which are, in turn, operated by the computer.

The polymerisation procedure is executed automatically by the robot under control of the computer. The procedure is as follows:

Firstly, the reactor vessel is loaded and saturated with ethylene. In this regard, PMH (70 ml), together with a predetermined amount of scavenger (or co-monomer), are added to pre-mixing vessel 24 by the robot. Then the temperature of the reactor vessel 4 is set 20° C. below a predetermined set point and the procedure is discontinued until the set temperature is reached. The contents of the vessel 24 are added to the reactor vessel 4 by opening valves 54, 56 and 58. After waiting a few seconds, valves 54, 56, 58 are closed and stirrer 10 is turned on. Brooks flow meter 60 is opened and its totalizer re-set to zero and then valve 62 is opened thereby to pressurise the reactor 4 with ethylene. After a few seconds valve 62 is closed and the reactor temperature is then set 10° C. below its set-point and the procedure discontinued until the set temperature is reached. Once the set temperature is reached, the Brooks flow meter 60 is opened totally and its totalizer reset. Then, by opening valve 62 the reactor vessel is pressurised to 20 bars of ethylene and the temperature rises to the set point. The gas saturation of the reactor vessel is thereby complete and the subsequent procedure will not continue until the flow as measured by the Brooks flow meter equals zero and the temperature equals the set-point.

Next, reagents are injected under pressure into the reactor vessel. (The catalyst used may be

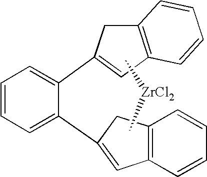

which may be prepared in the glovebox as a 0.0001 M solution in toluene. A co-catalyst may be MAO). In this regard, PMH, catalyst (and optionally co-catalyst) are added to the pre-mixing vessel 24 by the robot in a predetermined procedure (hereinafter referred to as the “charging PID”) which may suitably include stirring it and the mixture is mixed according to a predetermined procedure (hereinafter referred to as the “mixing PID”) for 1 minute before valves 58 and 64 are opened to introduce it into the injection chamber 20. After several seconds valves 58 and 64 are closed and valve 66 is opened for several seconds and then re-closed to pressurise the catalyst injection chamber 20. The Brooks flow meter 60 is opened totally and its totalizer reset to zero. At this stage 7.5 ml of PMH will already have been added to the pre-mixing vessel 24 for a second injection (whereby any remaining catalyst can be washed out of the vessel). Then, the first injection into the reactor vessel 4 takes place by opening and closing valve 56. After the first injection, the PMH for the second injection is introduced into injection chamber 20 by opening valves 58 and 64. After several seconds, valves 58 and 64 are closed and valve 66 is opened for several seconds (and closed again) to pressurise the injection chamber 20. The second injection into the chamber takes place by opening and closing valve 56.

While the polymerisation is ongoing, 100 ml of PMH for a first cleaning step of the apparatus is added by the robot to the pre-mixing vessel 24.

When the polymerisation has finished or after 30 minutes (whichever comes first), valve 62 is closed, thereby to shut off the ethylene supply, and the stirrer 10 is switched off. The polymer is collected in collection vessel 70 by opening drain valve 72 and, thereafter, it is re-closed. The collection vessel can then be disconnected from the apparatus and the polymer isolated. This may be undertaken automatically by a robot which may re-connect a clean collection vessel for collecting a polymer prepared in a subsequent reaction.

The computer then controls the cleaning of the apparatus and its preparation for another polymerisation reaction according to predetermined procedures.

During use of the apparatus, the temperature at predetermined locations, for example, the lid and body of the reactor, are monitored and controlled and data relating thereto is stored by the computer.

The apparatus also includes various alarm procedures including, for example, pressure and temperature alarms, which relay information to the computer which, in turn, controls safely measures taken (e.g. closing/opening of valves, switching off heaters etc,) in the event that an alarm is actuated.

The computer is arranged for input of a substantial amount of data relating to each polymerisation. There are two main types of data input: firstly, data describing general procedures used; and, secondly, data relating to experimental variables.

The following data describing general procedures may be input. In the following tables which describe data types, the first column is a short form description of the data; the second column describes the type of data (e.g. number or character); and the third gives a more detailed description of the data.

TABLE 1

| Column Name | Type | Description |
|---|---|---|
| CLEANING PID | NUMBER | The identifier that specifies |
| | | the procedure used to clean |
| | | the reactor vessel |
| PREPARATION PID | NUMBER | The identifier that specifies |
| | | the procedure used to |
| | | prepare the reactor vessel |
| INITIAL DRYING PID | NUMBER | The identifier that specifies |
| | | the procedure used to dry the |
| | | reactor vessel |
| CHARGING PID | NUMBER | The identifier that specifies |
| | | the procedure used to charge |
| | | the pre-mixing vessel |
| MIXING PID | NUMBER | The identifier that specifies |
| | | the procedure used to mix the |
| | | reactants in the pre-mixing |
| | | vessel |
| REACTION PID | NUMBER | The identifier that specifies |
| | | the procedure used to clean |
| | | the reactor vessel |
| DUMPING PID | NUMBER | The identifier that specifies |
| | | the procedure used to clean |
| | | the collection vessel |

The following data describing procedural variables may be input.

TABLE 2

| Column Name | Type | Description |
|---|---|---|
| REACTOR TEMPERATURE | NUMBER | The temperature in degrees |
| | | centigrade of the body of the |
| | | reactor vessel at the injection |
| | | of the mixture as measured |
| | | by a thermocouple |
| STIRRING RATE | NUMBER | The stirring rate (RPM) of |
| | | stirrer 10 in the reactor vessel |
| NITROGEN PRESSURE | NUMBER | The supply pressure of |
| | | Nitrogen (kPa) to line 22 |
| ETHYLENE PRESSURE | NUMBER | The supply pressure of |
| | | Ethylene (kPa) to line 14 |
| DURATION OF | NUMBER | The experiment duration |
| EXPERIMENT | | (seconds) |

Procedures undertaken in the apparatus are divided into a series of numbered stages and a table is constructed specifying what procedure (e.g. opening/closing particular valves, raising temperature, inputting components etc.) is undertaken at each stage. Also, where more than one procedure is undertaken at the same stage (e.g input of two components into a reaction), details relating to the order of such a procedure is noted. This enables any procedure to be reproduced.

The primary catalyst used in an experiment is referenced by identifying characters and various data relating thereto is stored, as follows:

TABLE 3

| Column Name | Type | Description |
|---|---|---|
| PRIMARY CATALYST ID | VARCHAR2 | The identifier for the sample |
| | | of primary catalyst. |
| PRIMARY CATALYST | NUMBER | The volume of primary |
| VOLUME | | catalyst added to the vessel |
| | | (ml) |
| PRIMARY CATALYST | NUMBER | The computed weight of |
| MASS ADDED | | primary catalyst added (g) |
| PRIMARY CATALYST | NUMBER | The computed amount of |
| MOL ADDED | | primary catalyst added (mol) |
| PRIMARY CATALYST | NUMBER | The stage number in which |
| STAGE ADDED | | the primary catalyst was |
| | | added to the apparatus |
| PRIMARY CATALYST | NUMBER | The order within the set of |
| STAGE ORDER | | reagents added at the same |
| | | time as the primary catalyst |

Other catalysts or co-catalysts may be added and these are identified as co-catalysts A to G giving eight potential co-catalysts. Data relating to co-catalyst A may be as follows. Data relating to co-catalysts B to G may be presented and stored in a similar manner.

TABLE 4

| Column Name | Type | Description |
|---|---|---|
| CATALYST A ID | VARCHAR2 | The identifier for the sample |
| | | of co-catalyst A |
| CATALYST A VOLUME | NUMBER | The volume of co-catalyst A |
| | | added to the vessel (ml) |
| CATALYST A MASS | NUMBER | The computed weight of co- |
| ADDED | | catalyst A added (g) |
| CATALYST A MOL | NUMBER | The computed amount of co- |
| ADDED | | catalyst A added (mol) |
| CATALYST A STAGE | NUMBER | The stage number in which |
| ADDED | | the co-catalyst A was added |
| | | to the apparatus |
| CATALYST A STAGE | NUMBER | The order within the set of |
| ORDER | | reagents added at the same |
| | | time as the co-catalyst A |

The solvent in which experiments are undertaken provides another set of important experimental variables. Of primary interest are the solvent type and quantity and of secondary interest, to be used mainly for quality assurance, is the exact batch of solvent involved. As with catalysts/co-catalysts, it is important to know exactly when the solvent was added and what was added at the same time.

One or more solvents identified as solvents 1 to 8 may be added. Data relating to solvent 1 may be as follows. Data relating to solvents 2 to 8 may be presented in a similar manner.

TABLE 5

| Column Name | Type | Description |
|---|---|---|
| SOLVENT 1 NAME | VARCHAR2 | Name of the first solvent. |
| SOLVENT 1 SUPPLIER | VARCHAR2 | Supplier identifier |
| SOLVENT 1 BATCH ID | VARCHAR2 | Supplier batch identifier |
| SOLVENT 1 STAGE | NUMBER | Stage number solvent 1 is |
| NUMBER | | added |
| SOLVENT 1 ORDER | NUMBER | Order within the solvents |
| NUMBER | | added in this stage |

Additionally, various parameters are measured during experiments, for example gas consumption and temperature change and data is stored. Temperature or gas traces are difficult to compare computationally and, accordingly, summary figures are prepared for use in analysis, as follows:

TABLE 6

| Column Name | Type | Description |
|---|---|---|
| TEMP TOTAL RISE | NUMBER | The temperature rise in the |
| | | body of the reactor vessel |
| | | between the start and end of |
| | | the experiment (° C.) |
| TEMP MAX RATE | NUMBER | The maximum temperature |
| | | rise rate over a 10 second |
| | | period (° C.) |
| FLOW TOTAL USED | NUMBER | The value on the totalizer at |
| | | the end of the experiment |
| | | (dm3) thereby providing the |
| | | total ethylene used |
| FLOW MAX RATE | NUMBER | The maximum amount of |
| | | ethylene used in a 10 |
| | | second period (dm3) |
| FLOW TIME TO HALF MAX | NUMBER | The time taken to reach half |
| | | the maximum flow rate |
| | | (seconds) |

The actual traces are stored as values vs time for temperature, pressure, ethylene consumed and % ethylene consumption.

After a polymer has been dumped in vessel 70 it may be taken away and analysed. Analytical information can also be input into the computer, for example, as follows:

TABLE 7

| Column Name | Type | Description |
|---|---|---|
| EXPERIMENT ID | NUMBER | Primary key references the |
| | | experiment table. |
| WEIGHT | NUMBER | Weight of a sample produced |
| | | (g) |
| GPC MODE WEIGHT | NUMBER | Mode molecular weight of |
| | | sample from GPC |
| GPC POLYDISPERSITY | NUMBER | Polydispersity of GPC sample |
| GPC FILE NAME | VARCHAR2 | Name of GPC file |
| GPC ARCHIVE | VARCHAR2 | Location of file archive |

Additionally, structural information relating to catalysts/co-catalysts used can be input.

The stored data described above may be held within an Oracle (Trade Mark) table. Proprietary software sold under the Trade Mark RS3 by Oxford Molecular Group Plc enables the data to be statistically analysed and searched.

The apparatus 200 of FIG. 4 differs from the apparatus 2 of FIG. 1 in that the apparatus 200 is adapted to allow more gas types to be input into the reactor vessel 4. To this end, a manifold 202 is provided upstream of the vessel 4. The manifold includes five gas inlets 204, 206, 208, 210 and 212 which, in an example, may be connected to supplies of ethylene (monomer gas), nitrogen (inert gas), propylene (monomer gas), hydrogen (chain transfer gas) and isobutane (solvent gas) respectively. The manifold communicates with the vessel 4 via inlet line 214.

The amounts of the five respective gases fed into the vessel 4 are controlled by respective mass flow controllers which also control the rate of gas feed. The mass flow controllers are controlled by a reactor control box 100 (FIG. 5) which sets the flow rates and the amounts of gases fed into the reactor. Each control box 100 communicates with a single central computer.

Since each reactant gas (e.g. ethylene, propylene, hydrogen) may be consumed at a different rate, the rates of flow are controlled independently, according to the composition of each gas in the reaction at points in time. To this end, the apparatus 200 includes a sampling capillary line 220 which passes through the manifold 202 and into the vessel 4. The line 220 is adapted to sample the gas in the vessel 4 and deliver samples to a mass spectrometer 102 (FIG. 5) which analyses it and delivers data relating thereto to the control box 100 which resets the mass flow controllers to make up for any differences in reaction rate and feed rate to thereby maintain a constant composition in the vessel 4. The capillary line 220 is heated so that gases therein do not separate based on their relative molecular weights.

As described above, an array of reactor vessels 4 is suitably provided. Each may incorporate a capillary line 220 as described above. However, one mass spectrometer may be used to analyse samples taken from the entire array of vessels 4. In this regard, an eight way switching valve 110 is arranged to allow sampling from one respective reactor at a time and, depending upon which rector 4 is being sampled, the mass spectrometer communicates relevant data to the appropriate control box 100.

In view of the modifications incorporated in the apparatus of FIG. 4, additional variables may be stored and/or controlled by the computer, as follows:

| | |
|---|---|
| Re: Table 2 | propylene pressure; |
| | hydrogen pressure. |
| Re: Table 6 | flow total for propylene; |
| | flow total for hydrogen; |
| | flow max rate for propylene; |
| | flow max rate for hydrogen; |
| | the ethylene:propylene:hydrogen ratios. |

The actual traces for propylene and hydrogen consumed and % consumption are, like the corresponding ethylene traces, stored as values vs time.

Whilst vessels 70 into which polymer may be dumped may be of any suitable type, a preferred dumping assembly is shown in FIGS. 6 and 7.

Referring to FIG. 6, the assembly includes a housing 300 which is fixed to a reactor vessel 4 (by means of fixings not shown). The housing includes an inlet 302 arranged to receive polymer from the vessel, an inlet 304 for inert gas (e.g. nitrogen) and a venting outlet 306 which communicates with the vessel 4.

The housing 300 includes a downwardly depending cylindrical outer skirt 308 and, spaced therefrom, a downwardly depending inner skirt 310. A dump vessel assembly 312 is arranged to be releasably engaged with the housing 300 and it comprises an outer support vessel 314 and a removable insert vessel 316. The vessel 314 includes three radially extending securement pins 318 (only one of which is shown) which are arranged to be releasably engaged within respective L-shaped slots 320 (FIG. 7) (only one of which is shown) in a wall of the skirt 308. The pins 318 and slots 320 are disposed at 120o intervals and are arranged such that the vessel 314 can be moved upwardly within skirt 308, so that the pins 318 pass through opening 322 of the L-shaped slot; and, thereafter, by twisting the vessel 314 through a small angle, the pins pass to a retaining position 324 in the slots wherein the vessel 314 is securely retained. Disengagement of the vessel 314 is achieved by twisting the vessel in an opposite direction so that the pins can be moved downwardly and out of the slot via opening 322.

The vessel 314 includes an O-ring 326 which is arranged to sealingly engage an inwardly facing part of skirt 308 and thereby seal the inside of the assembly 312 from the outside.

The insert vessel 316 is preferably a relatively cheap, lightweight, disposable vessel and may suitably be made of aluminium. Vessel 316 is cradled within vessel 314 and is arranged to directly receive polymer from the reactor vessel. The inner skirt 310 is arranged to reduce the risk of splashing as polymer is delivered into vessel 316. The skirt 310 also includes a removable lower portion 330 which may be detached from an upper portion 332 for cleaning or replacement.

The assembly allows automation of the polymer collection. In use of the assembly, nitrogen is supplied via inlet 304 into vessel 316 so that the polymer from the reaction vessel is dumped into an inert nitrogen environment. Therefore, a robot removes assembly 312 by engaging vessel 34 and twisting it to disengage pins 318 from the slots 320. The robot then removes insert vessel 316 and places it in a storage position; replaces the removed insert vessel with a clean vessel; and re-engages the assembly 312 with housing 300. Thereafter, a subsequently prepared polymer may be delivered into the new insert vessel and the procedure repeated as required.

Thus, a multiplicity of different polymers can be prepared in the reactor vessel and dumped automatically without any operator intervention.

It will be appreciated that a single robot may be used to engage/disengage respective dump vessel assemblies when an array of apparatus for preparing polymers is used.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A method for examining the effect in a chemical reaction of varying selected variables comprising preparing a catalyst system in a reactor using a first set of experimental variables and preparing an oligomer or polymer in a reactor using a second set of experimental variables and storing data relating to said first and second sets as electronic data.

2. A method according to claim 1, wherein the polymer is a polyolefin.

3. A method according to claim 1, wherein the reactor in which the catalyst system and the reactor in which the oligomer or polymer are prepared have a volume of at least 25 ml.

4. A method according to claim 1, which further comprises the use of a mass flow controller to make making up for any differences in reaction rate and feed rate to maintain a constant composition in the reactor.

5. A method according to claim 4, which further comprises assessing the amount of at least one of the components for the reaction present in the reactor at a plurality of intervals during a reaction and adjusting the amount of said at least one said component supplied to the reactor means according to the amount assessed.

6. A method according to claim 5, which further comprises assessing with mass spectroscopy the amount of at least one of the components for the reaction present in the reactor at a plurality of intervals during a reaction and adjusting the amount of said at least one said component supplied to the reactor according to the amount assessed.

7. A method according to claim 1, wherein at least two substantially identical apparatuses are provided, each of which is arranged to carry out chemical reactions and wherein a single computer is used to control independently the execution of the process in each apparatus.

8. A method according to claim 1, which comprises preparing a polymer via slurry polymerization or solution polymerization.

9. A method according to claim 1, which further comprises, after termination of the chemical reaction by which said oligomer or polymer is produced, automatically removing the oligomer or polymer produced under the control of a computer which controls operation of a valve associated with an outlet of the reactor.

10. A method according to claim 9, wherein the oligomer or polymer is dumped in a dumping assembly

11. A method according to claim 10, wherein the dumping assembly comprises a removable insert vessel.

12. A method according to claim 1, which further comprises, after the reaction for forming the oligomer or polymer is completed, automatically cleaning automatically cleaning the reactor under the control of a computer.

13. A system for examining the effect of adjusting selected variables in a chemical reaction, the system comprising an apparatus which includes:
a reactor;
a first supply means for supplying a first substance to the reactor;
a second supply means for supplying one or more components for the chemical reaction to the reactor;
wherein said system includes electronic data storage device associated with the apparatus for storing sets of variables relating to separate reactions undertaken using the apparatus.
